(19) United States
(12) Patent Application Publication
(10) Pub. No.: US 2014/0141283 A1
(43) Pub. Date: May 22, 2014

(54) METHOD FOR MANUFACTURING A FLUORESCENT RESIN FILM AND FLUORESCENT RESIN FILM MANUFACTURED THEREBY

(71) Applicants: Seung Jae Lee, Cheonan-si (KR); Na Na Park, Seoul (KR); Gyeong Seon Seon Park, Seoul (KR); Bo Kyoung Kim, Suwon-si (KR); Jong Rak Sohn, Hwaseong-si (KR); Chang Hoon Kwak, Seoul (KR)

(72) Inventors: Seung Jae Lee, Cheonan-si (KR); Na Na Park, Seoul (KR); Gyeong Seon Seon Park, Seoul (KR); Bo Kyoung Kim, Suwon-si (KR); Jong Rak Sohn, Hwaseong-si (KR); Chang Hoon Kwak, Seoul (KR)

(73) Assignee: SAMSUNG ELECTRONICS CO., LTD., Suwon-si, Gyeonggi-do (KR)

(21) Appl. No.: 14/127,878

(22) PCT Filed: Aug. 12, 2011
(86) PCT No.: PCT/KR2011/005927

§ 371 Date: Dec. 19, 2013

(51) Int. Cl. C09K 11/02; B05D 5/06

(52) U.S. Cl. CPC C09K 11/025; B05D 5/06
USPC 428/690; 427/157

(57) ABSTRACT

A method of manufacturing a phosphor resin film and a phosphor resin film manufactured thereby are provided. The method of manufacturing a phosphor resin film includes preparing a polymer slurry by mixing a polymer resin and a latent curing agent in a solvent, spreading the polymer slurry such that it has a film shape, drying the spread polymer slurry to form a semi-hardened resin film, and providing phosphor powder to the semi-hardened resin film. A phosphor resin film includes semi-hardened resin film including a polymer resin and a latent curing agent and phosphors uniformly formed on one surface of the semi-hardened resin film.

### BACKGROUND OF THE INVENTION

1. Field of the Invention

The present invention relates to a method of manufacturing a phosphor resin film and a phosphor resin film manufactured thereby, and more particularly, to a method of manufacturing a phosphor resin film capable of improving phosphor precipitation over time and uniformly coating a phosphor on a surface of a film, and a phosphor resin film manufactured thereby.

2. Description of the Related Art

Recently, light emitting diode (LED) devices have been used in mobile phone keypads, backlight units, and the like, and reductions in the size of LED packages, as well as high reliability thereof, are seen as being important characteristics.

A universal LED package manufacturing method includes connecting an LED device to pre-molded plastic body using lead frames, wire-bonding the LED device to lead frames, filling on a surface of the LED device and a space of the pre-molded plastic package with a polymer paste such as silicon with phosphors dispersed therein, and hardening the polymer paste.

For example, in the case that an LED package is configured to emit white light by using a blue LED and a phosphor, when light emitted from the blue LED passes through a phosphor such as, for example, CaYAG, a partial amount of the light is absorbed by the phosphor, while a remainder of light passes through the phosphor material. In this process, when light absorbed into the phosphor material is re-emitted, red and yellow-green light having a wavelength longer than that of light which was initially absorbed is emitted to generate white light together with blue light having the original wavelength.

In this case, in the related art molded form, an optical path of light having a shorter wavelength emitted upwardly from the chip and that of light emitted to the outside from a lateral surface of the chip through a reflective surface of a cup are different, and thus, light emitted to the lateral surface of the chip reacts significantly with the phosphor material to increase a great deal of red and yellow-green light. Thus, due to such an absorption and emission phenomenon, a phenomenon in which light having a different wavelength, rather than white light, is generated according to an emission direction and emitted, occurs.

Thus, in order to solve the problem, a technique using a film-type sheet in packaging has been developed. However, in manufacturing a film-type sheet, in a process of preparing a slurry including phosphors and forming it into a sheet, phosphors may be non-uniformly disposed within the film and phosphor powder may precipitate over time, resulting in a defective product due to non-uniform optical characteristics. Meanwhile, when a slurry is prepared according to the related art, a dispersing agent is additionally required to be used.

Thus, a method of manufacturing a phosphor resin film in which the use of a dispersing agent is not required and phosphors are uniformly distributed without being precipitated during a process of manufacturing a film including phosphors is required.

### SUMMARY OF THE INVENTION

An aspect of the present invention provides a method of manufacturing a phosphor resin film capable of allowing phosphors to be uniformly distributed across a large area.

Another aspect of the present invention provides a phosphor resin film manufactured through the foregoing method so as to have phosphors uniformly distributed therein.

Another aspect of the present invention provides a method of manufacturing a light emitting device having enhanced optical characteristics by using a phosphor resin film including phosphors uniformly distributed therein.

According to an aspect of the present invention, there is provided a method of manufacturing a phosphor resin film including: preparing a polymer slurry by mixing a polymer resin and a latent curing agent in a solvent; spreading the polymer slurry such that it has a film shape; drying the spread polymer slurry to form a semi-hardened resin film; and providing phosphor powder to the semi-hardened resin film.

According to another aspect of the present invention, there is provided a phosphor resin film including: a semi-hardened resin film including a polymer resin and a latent curing agent; and phosphors uniformly formed on one surface of the semi-hardened resin film.

The method may further include applying a release film to a surface of the semi-hardened resin film on which the phosphor powder is formed.

The providing of phosphor powder may include jetting the phosphor powder to the surface of the semi-hardened resin film by using an inkjet method.

The phosphor powder may be a yellow phosphor.

The phosphor powder may include two or more types of phosphors, producing different respective wavelengths of light.

The phosphor powder may include at least a red phosphor and a green phosphor.

The polymer resin may be a thermoplastic resin, a thermosetting resin, or a resin mixture obtained by mixing the thermoplastic resin and the thermosetting resin.

The latent curing agent may be a curing agent based on dicyandiamide (DICY) or imidazole.

The solvent may be at least one selected from among toluene and methyl-ethyl-ketone (MEK).

According to another aspect of the present invention, there is provided a method of manufacturing a light emitting device including: preparing a phosphor resin film by forming a phosphor powder on one surface of a resin film obtained by semi-hardening a mixture of a polymer resin and a latent curing agent in a B-stage; applying the phosphor resin film to a light emitting device; and completely hardening the semi-hardened phosphor resin film.

The method may further include: applying a release film to a surface of the semi-hardened resin film on which the phosphor powder is formed.

In the applying of the phosphor resin film to the light emitting device, the phosphor resin film may be applied such that the surface of the phosphor resin film on which the phosphor powder is not formed is in contact with the light emitting device.

The applying of the phosphor resin film to the light emitting device may be performed on a wafer level.

The applying of the phosphor resin film to the light emitting device may be performed on a package level.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically illustrating a process of manufacturing a phosphor resin film according to an embodiment of the present invention;

FIG. 2 is a view schematically illustrating a cross-section of a phosphor resin film according to an embodiment of the present invention;

FIG. 3 is a view illustrating a process of transferring the phosphor resin film of FIG. 1 to a pre-molded package by applying pressure thereto; and

FIG. 4 is a view illustrating a package obtained by laminating a phosphor resin film on a flip-chip LED.

### DETAILED DESCRIPTION OF THE PREFERRED EMBODIMENT

Embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

An embodiment of the present invention relates to a method of manufacturing a phosphor resin film including: mixing a polymer resin and a latent curing agent in a remaining amount of solvent to prepare polymer slurry; spreading the polymer slurry such that the polymer slurry has a film shape; drying the spread polymer slurry to form a semi-hardened resin film; and providing phosphor powder on the semi-hardened resin film, in manufacturing a film including phosphors used for an LED package.

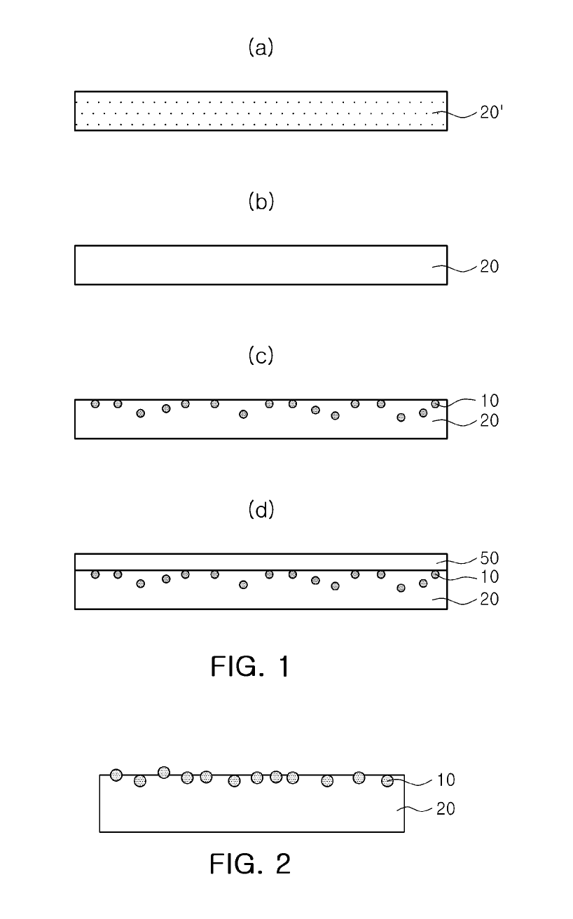

FIG. 1 is a view schematically illustrating a process of manufacturing a phosphor resin film according to an embodiment of the present invention. A polymer resin and a latent curing agent are mixed in a solvent to prepare the polymer slurry and the polymer slurry is spread to have a film shape (a), the spread polymer slurry is dried to form a semi-hardened resin film (b), and phosphor powder is subsequently provided to the semi-hardened resin film (c). Meanwhile, the method may further include applying a release film to the surface of the semi-hardened resin film on which the phosphor powder provided is formed.

First, according to an embodiment of the present invention, polymer slurry is prepared by mixing polymer resin excluding a phosphor and a latent curing agent in a solvent.

The polymer resin used in an embodiment of the present invention may be able to be dried in the form of a film so as to be fabricated as a semi-hardened resin film, and preferably, the polymer resin is flexible before being hardened for the easiness of handling.

In an embodiment of the present invention, a thermoplastic resin or a thermosetting resin may be used as the polymer resin, and preferably, a mixture of a thermoplastic resin and a thermosetting resin is used. In particular, as the polymer resin according to an embodiment of the present invention, a resin mixture obtained by mixing 30˜70 parts by weight of a thermoplastic resin and 30˜70 parts by weight of a thermosetting resin may be used.

Based on the overall polymer slurry, 40 to 80 parts by weight of the polymer resin may be included.

In the polymer resin according to an embodiment of the present invention, the thermoplastic resin may serve to provide spreadability for spreading and flexibility of the phosphor resin film, and the thermosetting resin may serve to provide adhesive strength and mechanical characteristics after the phosphor resin film is hardened.

In an embodiment of the present invention, one or more selected from polyester, polypropyleneoxide, polyacrylate, polyvinylidene fluoride, and a phenoxy resin may be used as an example of the thermoplastic resin, and one or more selected from among epoxy, polyimide, acrylate, silicon, and a polyester resin may be used as an example of the thermosetting resin.

Preferably, a curing agent used to harden the resin in an embodiment of the present invention is a latent curing agent. The latent curing agent does not allow a polymer resin at be cured at room temperature, and only allows a polymer resin to be cured when a temperature is increased. In the case of using general thermosetting, viscosity may be severely changed in the process of coating polymer slurry, resultantly negatively affecting uniformity of a thickness to thereby increase tolerance.

As an example of a latent curing agent, a latent curing agent based on dicyandiamide (DICY) or imidazole may be used, and 1 to 10 parts by weight of the latent curing agent based on the polymer slurry may be included.

In an embodiment of the present invention, the polymer slurry is prepared by mixing the polymer resin and the latent curing agent to a remaining amount of solvent, and here, toluene or methyl-ethyl-ketone (MEK) may be used as the solvent. Preferably, a mixture solvent obtained by mixing toluene and MEK is used.

After preparing the polymer slurry obtained by mixing the polymer resin and the latent curing agent in the solvent, the polymer slurry is spread to have a film shape. The polymer slurry may be spread on a release film which allows polymer slurry to be spread thereon and dried to obtain a semi-hardened polymer resin film, or on an appropriate support material known in the art. For example, the polymer slurry may be spread on a polyester or polyimide release film, but the present invention is not particularly limited thereto.

Subsequently, the spread polymer slurry is dried to form a semi-hardened resin film. For example, the polymer slurry may be spread in the form of a film and dried at 100 150 until when it is semi-hardened (B-stage) to obtain a semi-hardened resin film.

When the semi-hardened resin film is obtained, a phosphor is provided to the resin film. The phosphor may be provided according to an inkjet method but the present invention is not limited thereto and any technique known in the art that is able to uniformly provide or spread a phosphor may be used.

In an embodiment of the present invention, various phosphors may be selectively used according to color of LED and optical characteristics. In an embodiment of the present invention, one or more selected from among a white light emitting phosphor, a red phosphor, a green phosphor, and a yellow phosphor may be used as an example of the foregoing phosphor. As the phosphor powder, two or more types of phosphors producing different respective wavelengths of light may be used together, and here, the phosphor powder may include at least a red phosphor and a green phosphor. Any phosphor known in the art may be used as the foregoing phosphor without being particularly limited.

A general phosphor powder has a particle diameter ranging from 10˜15 μm, but in an embodiment of the present invention, the phosphor powder having smaller particle diameter may be contained to exhibit even dispersibility in the semi-hardened phosphor resin film.

When the phosphor powder is provided to the semi-hardened resin film, the phosphor powder may be provided such that it forms one or a plurality of layers in the resin film from one surface of the resin film. A distance between phosphor powder particles may be adjusted according to an application range.

Subsequently, as shown in FIG. 1(d), a release film 50 may be attached to the surface of the phosphor powder of the resin film. In addition, after the release film is attached, a pressurization operation may be performed with a roller, or the like. The attaching of the release film and the pressurization operation may be performed by using any method known in the art without being particularly limited.

In an embodiment of the present invention, the use of an extra dispersing agent is not required, and since the semi-hardened resin film is manufactured and the phosphor having a uniform thickness is subsequently provided, precipitation of the phosphor over time can be prevented even while the film is being manufactured, and in addition, the phosphor may be uniformly spread to be thin on the surface of the film.

In another aspect of the present invention, a phosphor resin film including a semi-hardened resin film including a polymer resin and a latent curing agent is provided, and a phosphor is uniformly formed on one surface of the semi-hardened resin film.

In the present disclosure, the term ‘one surface of the resin film’ encompasses concepts including a thickness of the resin film and is used to designate directionality of one of both surfaces. Namely, the phosphor powder is not limited to existing as a single layer only on one surface of the phosphor resin film but may be understood to exist as one layer or a plurality of layers starting from the one surface and having a certain depth or thickness of the phosphor resin film. Preferably, the phosphor may exist as a plurality of layers including first to fourth layers within the resin film. Preferably, the phosphor powder may exist from one surface of the resin film to a region of about 50% of the thickness of the resin film. An interval between the phosphor powder particles may be adjusted as necessary. FIG. 2 illustrates an exemplary phosphor resin film obtained by uniformly forming the phosphor powder particles 10 on one surface of the hardened resin film 20.

Another aspect of the present invention provides a method of manufacturing a light emitting device including preparing a phosphor resin film by forming a phosphor powder on one surface of a resin film obtained by semi-hardening a mixture of a polymer resin and a latent curing agent in a B-stage; applying the phosphor resin film to a light emitting device; and completely hardening the semi-hardened phosphor resin film.

The operation of preparing the phosphor resin film including phosphor powder by forming a phosphor powder on one surface of the resin film obtained by semi-hardening the mixture of the polymer resin and the latent curing agent in a B-stage state is performed as described above.

In applying the phosphor resin film to the light emitting device, preferably, the phosphor resin film is applied such that the surface of the phosphor resin film on which the phosphor powder is not formed is in contact with the light emitting device.

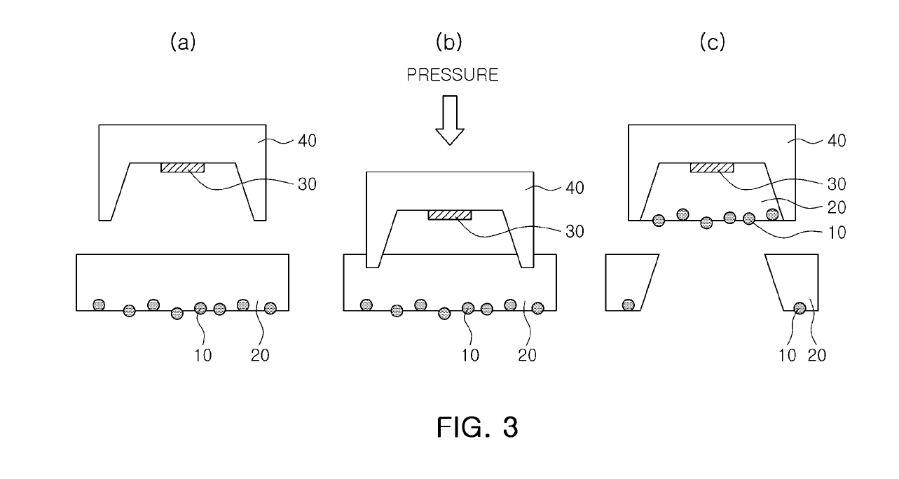

FIG. 3 is a schematic view illustrating a process of applying the phosphor resin film according to an embodiment of the present invention to a flip chip LED chip. Specifically, FIG. 3 is a schematic view illustrating a process of transferring the phosphor resin film according to an embodiment of the present invention to a pre-molded LED package by applying pressure thereto. In case of a single chip, the LED package 40 uses a pre-molded package in most cases, and in this case, fine holes are formed within the package in order to facilitate the transfer of the phosphor resin film.

Referring to FIG. 3, the flip-chip LED 30 and the phosphor resin film are reversed so that the surface of the phosphor resin film on which the phosphor powder is not formed, is brought into contact with the LED chip 30 (a). Subsequently, pressure is applied from an upper side and vacuum is applied from the flip-chip side to thereby uniformly coat and stack the phosphor resin film on the entire surface of the flip-chip LED structure, to form a phosphor resin film (b and c). Meanwhile, an operation of applying a release film to the surface of the semi-hardened resin film on which the phosphor powder is formed may be subsequently performed (not shown).

After the LED chip is attached and wire-bonded, the lead frame strip of the package 40 is reversed and pressure is then applied toward the phosphor resin film, and in this case, vacuum is applied through fine holes provided in the package within the package, thus allowing the phosphor resin film to be filled in the space within the package without bubbles.

Finally, when the transfer within the package of the phosphor resin film is terminated, the phosphor resin film is hardened through thermosetting or UV setting, thus terminating the LED package manufacturing process.

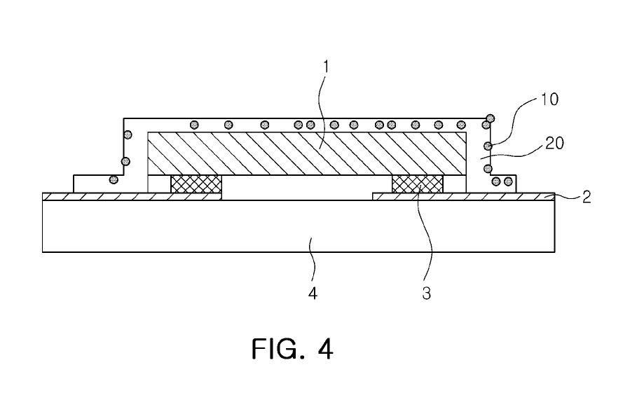

Since the phosphor resin film according to an embodiment of the present invention is manufactured in the B-stage state, a certain amount of phosphor resin film can be transferred and hardened by pressing the frame edge of the LED pre-molded package to the phosphor resin film through punching, or the like. Also, a lamination operation as shown in FIG. 4 may also be performed.

The operation of applying the phosphor resin film to the light emitting device may be performed on any of a wafer level or a package level.

As described above, by preventing precipitation of phosphor powder during a film manufacturing process and improving non-uniform optical characteristics otherwise due to precipitation of phosphor powder, the phosphor resin film according to an embodiment of the present invention can have uniform phosphor distribution over a large area, excellent phosphor characteristics, and uniform optical characteristics.

As set forth above, in case of the method of manufacturing a phosphor resin film according to embodiments of the invention, since the semi-hardened film is manufactured and phosphor particles are subsequently provided, phosphor particles can be uniformly distributed over a large area, and the phosphor resin film can have excellent LED phosphor characteristics and can be transferred to or laminated on various LED chips and package structures. According to the method of the present invention, precipitation of phosphor powder, non-uniform optical characteristics due to the precipitation of phosphor powder, and adjustments of the distribution amount of a paste, or the like, can be improved.

While the present invention has been shown and described in connection with the embodiments, it will be apparent to those skilled in the art that modifications and variations can be made without departing from the spirit and scope of the invention as defined by the appended claims.

What is claimed is:

1. A method of manufacturing a phosphor resin film, the method comprising:
preparing a polymer slurry by mixing a polymer resin and a latent curing agent in a solvent;
spreading the polymer slurry such that it has a film shape;
drying the spread polymer slurry to form a semi-hardened resin film; and
providing phosphor powder to the semi-hardened resin film.

2. The method of claim 1, further comprising applying a release film to a surface of the semi-hardened resin film on which the phosphor powder is formed.

3. The method of claim 1, wherein the providing of phosphor powder includes jetting the phosphor powder to the surface of the semi-hardened resin film by using an inkjet method.

4. The method of claim 1, wherein the phosphor powder is a yellow phosphor.

5. The method of claim 1, wherein the phosphor powder includes two or more types of phosphors producing different respective wavelengths of light.

6. The method of claim 5, wherein the phosphor powder includes at least a red phosphor and a green phosphor.

7. The method of claim 1, wherein the polymer resin is a thermoplastic resin, a thermosetting resin, or a resin mixture obtained by mixing the thermoplastic resin and the thermosetting resin.

8. The method of claim 1, wherein the latent curing agent is a curing agent based on dicyandiamide (DICY) or imidazole.

9. The method of claim 1, wherein the solvent is at least one selected from among toluene and methyl-ethyl-ketone (MEK).

10. A phosphor resin film comprising:
a semi-hardened resin film including a polymer resin and a latent curing agent; and
phosphors uniformly formed on one surface of the semi-hardened resin film.

11. The phosphor resin film of claim 10, further comprising a release film applied to a surface of the semi-hardened resin film on which the phosphor powder is formed.

12. The phosphor resin film of claim 10, wherein the phosphor powder is a yellow phosphor.

13. The phosphor resin film of claim 10, wherein the phosphor powder includes two or more types of phosphors producing different respective wavelengths of light.

14. The phosphor resin film of claim 13, wherein the phosphor powder includes at least a red phosphor and a green phosphor.

15. The phosphor resin film of claim 10, wherein the polymer resin is a thermoplastic resin, a thermosetting resin, or a resin mixture obtained by mixing the thermoplastic resin and the thermosetting resin.

16. The phosphor resin film of claim 10, wherein the latent curing agent is a curing agent based on dicyandiamide (DICY) or imidazole.

17. The phosphor resin film of claim 10, wherein the solvent is at least one selected from among toluene and methyl-ethyl-ketone (MEK).

18. A method of manufacturing a light emitting device, the method comprising:
preparing a phosphor resin film by forming a phosphor powder on one surface of a resin film obtained by semi-hardening a mixture of a polymer resin and a latent curing agent in a B-stage;
applying the phosphor resin film to a light emitting device; and
completely hardening the semi-hardened phosphor resin film.

19. The method of claim 18, further comprising applying a release film to a surface of the semi-hardened resin film on which the phosphor powder is formed.

20. The method of claim 18, wherein, in the applying of the phosphor resin film to the light emitting device, the phosphor resin film is applied such that the surface of the phosphor resin film on which the phosphor powder is not formed is in contact with the light emitting device.

21. The method of claim 18, wherein the applying of the phosphor resin film to the light emitting device is performed on a wafer level.

22. The method of claim 18, wherein the applying of the phosphor resin film to the light emitting device is performed on a package level.
